(19) United States
(12) Patent Application Publication
(10) Pub. No.: US 2003/0233331 A1
(43) Pub. Date: Dec. 18, 2003

(54) Online credit card security method

(76) Inventors: Timothy Laudenbach, Sartell, MN (US); Stephen Goff, Hopkins, MN (US)

Correspondence Address: Beck & Tysver, P.L.L.C., Suite 100, 2900 Thomas Avenue S., Minneapolis, MN, 55416, US

(21) Appl. No.: 10/175,489

(22) Filed: Jun. 18, 2002

(51) Int. Cl. G06F 17/60

(52) U.S. Cl. 705/64

(57) ABSTRACT

A method is presented for handling on-line-issued credit cards differently the first time the credit card is used at an e-commerce web site. The method examines all credit cards used in transactions on the web site. If the credit card is determined to be one that has been issued on-line (or issued in another high-risk manner), the method will determine whether this is the first time the credit card has been used at the web site. If so, the system will institute a delay of approximately four hours in the transaction to allow a more complete fraud analysis to be undertaken. One technique for determining whether the credit card has been issued in a high-risk manner is to assign all credit cards issued in such a manner a card number within a predefined range of numbers. All that is then necessary to make the determination is to determine whether the credit card being used in a transaction is within that range of numbers.

### TECHNICAL FIELD

The present invention relates to the field of credit card security. More specifically, the present invention relates to a security method used in an on-line, e-commerce web site when certain high-risk credit cards are used for the first time.

### BACKGROUND OF THE INVENTION

It is well known to allow a user of an e-commerce web site to apply for credit during an online session. The application is processed and approved in real-time. Once the application is approved, the credit line is instantly available for purchases at the e-commerce site.

In some systems, the credit card number permanently associated with the approved line of credit is presented to the user through the browser interface immediately after the credit application is approved. This credit card number can then be written down by the user, and used either in the on-line e-commerce environment, or in a bricks & mortar store associated with the e-commerce web site. Even where the credit card number is not immediately presented to the applicant upon approval, it is possible for credit to be made immediately available for use by the applicant. This can be done using cookies, password logins, or other tracking mechanisms that will associate the user of the e-commerce site with the newly approved line of credit.

Both the credit line issuer and the e-commerce site use fraud analysis techniques to catch fraudulent transactions. Unfortunately, some of these techniques cannot be automated, and must be accomplished manually. Therefore, these techniques are often by-passed in situations where “instant” or fast credit is provided to customers, especially in circumstances where that credit is immediately made available for purchases. This causes some fraudulent transactions to be accepted where those transactions would have been caught had more time been available to analyze the credit application.

### SUMMARY OF THE INVENTION

The present invention solves this problem by associating a certain range of credit card numbers with high-risk credit situations. Specifically, all credit cards approved via an on-line application interface are given a credit card number within a first range, while credit cards applied for by mail or in person are given a number within a second range. When an e-commerce transaction is received using a credit card, the card number is examined to determine whether the number is within the first range of numbers. If it is, a second check is performed to determine whether the credit card has been previously used at the e-commerce web site. If not, which indicates a first time use of a high-risk credit card, the system will institute an approximately four hour delay in the transaction to allow a more complete fraud analysis to be undertaken.

### BRIEF DESCRIPTION OF THE DRAWING

FIG. 1 is a flow chart showing the method of the present invention.

### DETAILED DESCRIPTION OF THE INVENTION

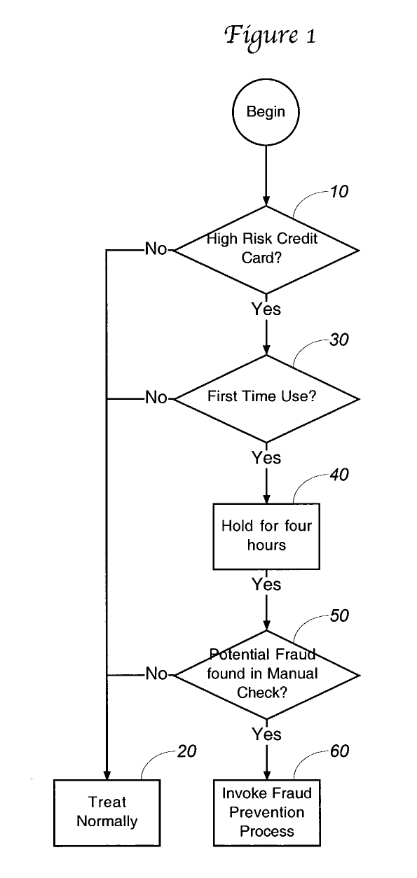

FIG. 1 shows a method for using a four-hour hold period on first time purchases made using the newly approved credit line at the e-commerce site. As shown in that FIGURE, the method first examines whether transaction uses a credit card that is identified as having been issued in a high risk situation, such as through an on-line credit process. This is step 10 in the method of FIG. 1. If the credit card is not considered a high-risk card, then the transaction is treated normally at step 20.

If the credit card was issued in a high-risk situation, then step 30 determines whether this is the first time that a purchase is made at the e-commerce site using the credit card. If not, then the transaction is also treated normally at step 20.

If step 30 determines that this is the first time that the high-risk credit card has been used, then the purchase transaction will be subject to a temporary hold of approximately four hours. During such a hold, the purchased products will not be processed for shipment to the purchaser.

After the hold period is complete, the analysis accomplished during the hold period can be examined in step 50. If the fraud analysis has determined that the transaction is possibly fraudulent, then the typical process used by the e-commerce site or the credit line issuer can be invoked in step 60. During this fraud prevention process, the purchase transaction will likely be delayed indefinitely until the fraud prevention process is completed, or perhaps even cancelled altogether. If step 50 does not determine the transaction to be suspicious after the hold period has expired, then the transaction will be allowed to be completed normally in step 20.

By singling out first time purchases from newly created credit accounts applied for on-line, the present system will delay only a small subset of total purchases for a complete fraud analysis. Four hours is considered the preferred delay time-period because it is short enough that the purchaser will not usually notice that any delay has taken place, and long enough to allow manual fraud prevention activities to take place.

The four-hour period generally runs only during those hours in which manual fraud prevention activities can occur. This will likely be less than twenty-four hours a day, since the manual fraud activities may include an attempt to contact the individual requesting the credit. If manual fraud prevention activities are not taking place during the entire four hours after an order has been placed, the hold will remain on the order until a total of four hours of working time has been made available for manual fraud prevention.

The method of FIG. 1 requires a technique for determining whether a particular credit card was issued in a high-risk manner. One way of doing so is to provide a subset of credit card numbers that are made available only through on-line credit applications. Thus, when the e-commerce system detects one of these credit card numbers being used for the first time, the fraud prevention delay can be implemented. First time purchases using credit card numbers outside of the subset reserved for on-line credit applications will not be subject to the hold period. In fact, this same system could be used any time that credit card numbers have been pre-sorted according to fraud risks. If the credit card number within a high fraud-risk subset is used for the first time, a delay in handling the purchase transaction can be utilized to allow complete fraud prevention analysis.

Many possible combinations of features and elements are possible within the scope of the present invention. Therefore, the scope of the present invention is not to be limited to the above description, but rather is to be limited only by the following claim.

1. A method for handling a transaction at an e-commerce web site associated with a credit card number, the method comprising:
a. determining whether the credit card number is considered high risk by examining whether the credit card number falls within a set of numbers predetermined to be high-risk;
b. if the credit card number is considered high-risk, then determining whether the transaction should be subject to a hold by examining whether the credit card number has been used previously at the e-commerce web site; and
c. if the transaction should be subject to a hold, holding the transaction for approximately four hours, thereby allowing additional manual fraud analysis to be conducted on the transaction.
